(19) United States
(12) Patent Application Publication
(10) Pub. No.: US 2025/0344906 A1
(43) Pub. Date: Nov. 13, 2025

(54) PORTABLE APPLIANCE HANDLE

(71) Applicant: Zachary David Dinicola, Augusta, KS (US)

(72) Inventor: Zachary David Dinicola, Augusta, KS (US)

(21) Appl. No.: 19/201,632

(22) Filed: May 7, 2025

Related U.S. Application Data
(60) Provisional application No. 63/731,466, filed on May 7, 2024.

(51) Int. Cl. A47J 43/07; A47J 43/044

(52) U.S. Cl. CPC A47J 43/0705; A47J 43/044; A47J 2043/04454

(57) ABSTRACT

A portable appliance comprises a motor housing, an attachment hub, and a handle. The attachment hub extends from the motor housing and has an outer surface with an opening. The handle comprises a collar portion, a fastening member, a stem portion, and a grip portion. The collar portion has a first opening and a second opening. The first opening receives and engages the outer surface of the attachment hub. The second opening is aligned with the opening of the attachment hub. The fastening member is received within the opening of the attachment hub and extends through the second opening to secure the collar portion to the attachment hub. The stem portion extends outwardly from the outer side of the collar portion. The grip portion extends from a second end of the stem portion. The grip portion is contiguous with the stem portion.

### CROSS-REFERENCE TO RELATED APPLICATIONS

This application claims priority to the provisional patent application identified by U.S. Ser. No. 63/731,466, filed May 7, 2024, the entire content of which is hereby expressly incorporated herein by reference.

### BACKGROUND

Portable appliances, such as all-purpose mixers, are devices that use a gear-driven mechanism to automate physical tasks like stirring, beating, whisking, and kneading. Developed in the early twentieth century, the functionality and practicality of portable mixers have made them a present-day staple in both domestic and commercial settings. Modern appliances, particularly stand mixers, are multi-purpose due to an attachment hub that provides access to powertrain of the mixer.

Portable overhead mixers/agitators, like stand mixers, typically incorporate a drive motor, gearbox, and transfer gears into an overhead unit that is mounted upon a frame. Although varying in size, from floor models to counter top models, a heavy motor-bearing head is a hallmark feature of many portable mixing appliances.

Accordingly, operation of such appliances requires handling of heavy head-units and the associated moving parts. For example, handling stand mixers presents particular demands upon the user to lift the machine for placement and lift the heavy tilt-head during regular operation. In such cases, this also demands handling directly at or near the mixer's moving parts, like beaters or blades. Even with cautious handling, fingers or hands can easily come into accidental contact with these parts, causing potentially serious injuries. Altogether, regular stand mixer handling and operation presents ample risk for accidental arm, hand, and finger injuries.

### SUMMARY

Hence, there is a need for a handle suited to the existing design features of many portable appliances, particularly stand mixers, that provides a grip for stable handling and operation. Such an improvement should minimize the risks associated with maneuvering heavy head-units with nearby moving parts, providing a safer, and more convenient, grip for operating and moving a portable appliance. The present disclosure addresses these issues through a novel portable appliance handle that is suited for portable appliances having an attachment hub, like stand mixers.

The lack of safe gripping options for portable appliances is addressed through the portable appliance and handle herein disclosed. The portable appliance comprises a motor housing, an attachment hub, and a handle. The attachment hub extends outward from the motor housing and has an outer surface with an opening. The handle comprises a collar portion, a fastening member, a stem portion, and a grip portion. The collar portion has a front side, a rear side, an outer side, an inner side defining a first opening extending from the front side to the rear side and a second opening extending from the outer side of the collar portion to the inner side. The first opening receives and engages the outer surface of the attachment hub. The second opening aligned with the opening of the attachment hub. The fastening member is received within the opening of the attachment hub and extends through the second opening of the collar portion to secure the collar portion to the attachment hub. The stem portion extends outwardly from the outer side of the collar portion. The stem portion has a first end contiguous with the outer side of the collar portion and a second end. The grip portion extends from the second end of the stem portion. The grip portion has a first end contiguous with the second end of the stem portion and a second end.

The handle may be for a portable appliance having an attachment hub and a fastening member. The attachment hub may include an outer surface with an opening for receiving the fastening member. The handle further comprises a collar portion, a fastening member, a stem portion, and a grip portion. The collar portion has a front side, a rear side, an outer side, an inner side defining a first opening extending from the front side to the rear side. The first opening receives and engages the outer surface of the attachment hub. The second opening extends from the outer side of the collar portion to the inner side. The second opening is aligned with the opening of the attachment hub. The fastening member is received within the opening of the attachment hub and extends through the second opening of the collar portion to secure the collar portion to the attachment hub. The stem portion extends outwardly from the outer side of the collar portion. The stem portion has a first end contiguous with the outer side of the collar portion and a second end. The grip portion extends from the second end of the stem portion. The grip portion has a first end contiguous with the second end of the stem portion and a second end.

In another embodiment, the handle may be integrated with a portable appliance via the attachment hub of the portable appliance. The handle generally comprises a collar portion, a stem portion, and grip portion; the stem portion extends from the collar portion and the grip portion extends from and is supported by the stem portion. A first opening extends from a front side to a rear side of the collar portion. A second opening extends from an outer side to an inner side of the collar portion. In another aspect, a portable appliance having a handle is disclosed herein. The collar portion of the handle may slide around the outer surface of the attachment hub of a portable appliance, and thus receive and engage the attachment hub. The second opening of the handle may accommodate a fastening member of the portable appliance; the fastening member may be received by both the second opening of the handle and the opening of the attachment hub to secure the handle to the portable appliance.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

The details of one or more implementations of the subject matter of this specification are set forth in the accompanying drawings and the description below. Other aspects, features, and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is an illustration of a stand mixer with an exemplary embodiment of a handle installed in accordance with the present disclosure.

FIG. 2A is a side view of an exemplary embodiment of a portable appliance attachment hub without a handle constructed in accordance with the present disclosure.

FIG. 2B is a side view of an exemplary embodiment of a portable appliance attachment hub with a handle constructed in accordance with the present disclosure.

FIG. 3 is a perspective view of an exemplary embodiment of a handle in accordance with the present disclosure.

FIG. 4 is a side view of an exemplary embodiment of a handle in accordance with the present disclosure.

FIG. 5 is an illustration of an exemplary embodiment of an external attachment constructed in accordance with the present disclosure.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

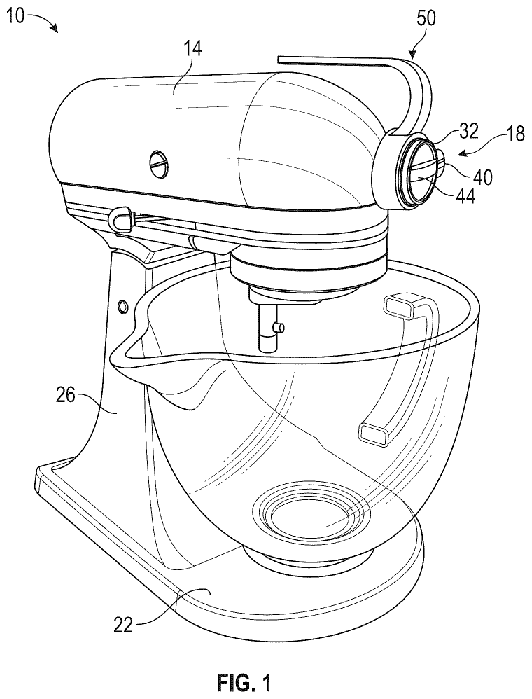

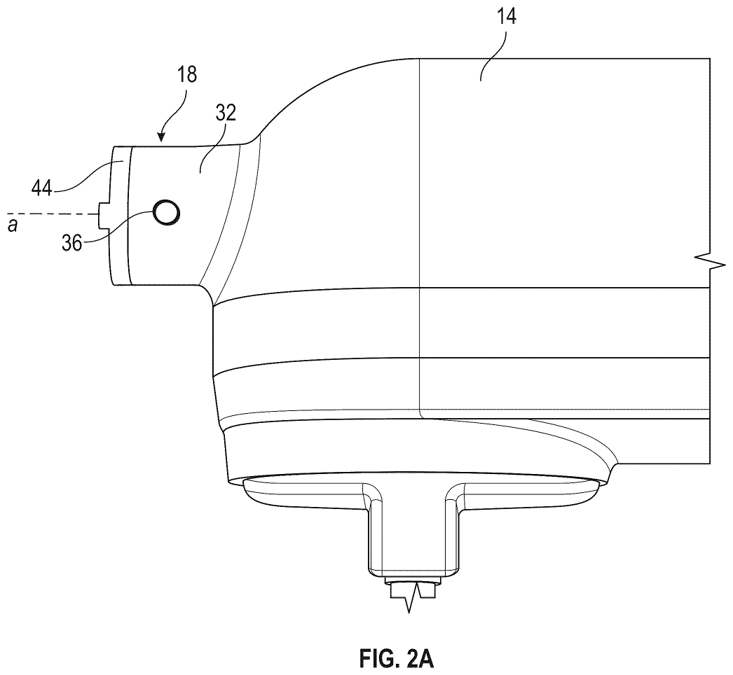

Referring now to the drawings, in particular to FIGS. 1, 2A, and 2B in combination, shown therein are illustrations of an exemplary embodiment of a portable appliance 10 having a handle 50 constructed in accordance with the present disclosure. It is contemplated that the portable appliance 10 of the present disclosure may generally include a motor housing 14, an attachment hub 18, and a handle 50. The motor housing 14, which may be constructed to support and house a motor (not shown), electronics (not shown), a gear assembly (not shown), and other components of the portable appliance 10. The motor housing 14 may be supported by a base 22 and/or a frame 26.

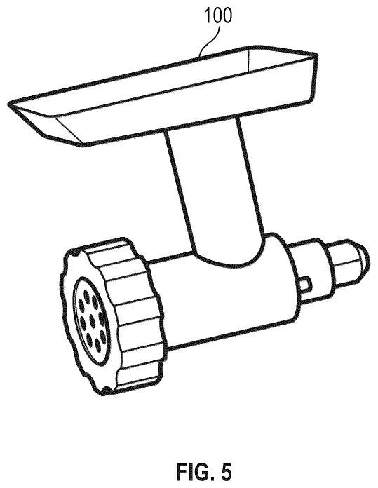

The attachment hub 18 may extend outward from the motor housing 14 and have an outer surface 32 that may be contiguous with the motor housing 14. The attachment hub 18 may also have an opening 36, and a fastening member 40 which extends through the opening 36 to secure an attachment hub cover 44 or any other external attachments 100 (shown, for example, in FIG. 5) to the motor housing 14. The fastening member 40 may engage the opening 36 via any mechanism suited to obtain a secure reversible coupling. For example, the fastening member 40 may be a screw, a bolt, a latch, a pin, a lock, a magnetic or mechanical catch, a knob, an interlocking joint, a clamp, combinations thereof, and/or the like. In one exemplary embodiment, as shown in FIG. 2, the fastening member 40 is a thumb screw that threadedly engages the opening 36.

Exemplary implementations of a portable appliance 10 may include, but is not limited to, mixers, grinders, tenderizers, juicers, and/or the like. In some exemplary embodiments, as illustrated in FIG. 1, the portable appliance 10 may be a stand mixer, such as the KitchenAid K5A (Whirlpool Corporation, Benton Harbor, MI). The portable appliance 10 may have a primary functionality of any type, and secondary functionalities via the attachment hub 18. External attachments (not shown) may be any number of versatile appliances and/or accessories that provide any number of secondary functionalities, such as mills, grinders (e.g., as shown in FIG. 5), cutters, rollers, peelers, shredders, sifters, pasta makers, spiralizers, and/or the like. Upon engaging the attachment hub 18, external attachments may be stabilized and/or provided transmission via the motor housing 14 of the portable appliance 10. When an external attachment is not engaging the attachment hub 18, the attachment hub cover 44 may engage the attachment hub 18.

The number of features and/or components illustrated in FIGS. 1, 2A, and 2B is provided for explanatory and illustrative purposes. In practice, there may be additional devices and/or components, fewer devices and/or components, different devices and/or components, or differently arranged devices and/or components than are shown in FIGS. 1, 2A, and 2B. Furthermore, two or more of the components illustrated in FIGS. 1, 2A, and 2B may be implemented within single components, or single components illustrated in FIGS. 1, 2A, and 2B may be implemented as multiple, distinct components. The number of components of the portable appliance 10 is shown for simplicity.

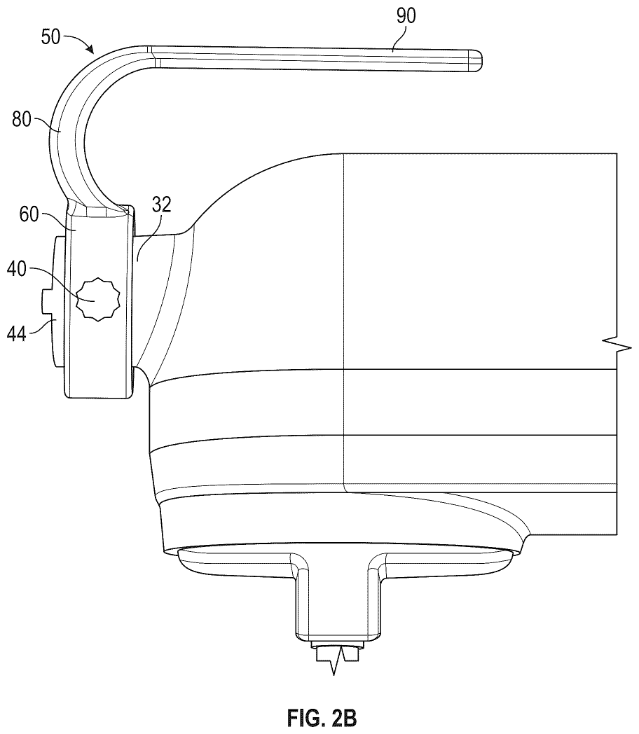

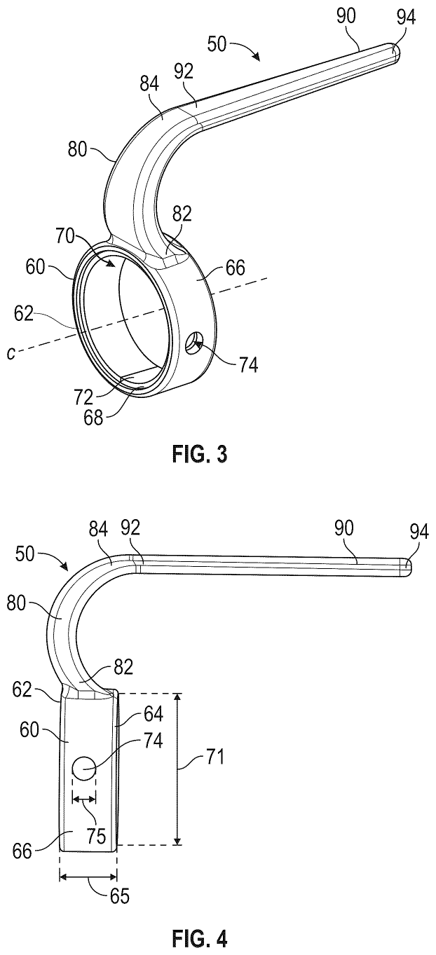

Turning now to FIGS. 3 and 4, shown therein is an exemplary embodiment of the handle 50 constructed in accordance with the present disclosure. The handle 50 generally comprises a collar portion 60, a stem portion 80, and grip portion 90. The stem portion 80 extends from the collar portion 60 and the grip portion 90 extends from and is supported by the stem portion 80.

The collar portion 60 includes a front side 62, a rear side 64, an outer side 66, and an inner side 68. In one embodiment, the collar portion 60 may be any variety of ring-like shapes to accommodate a variety of attachment hubs 18 across a variety of portable appliances 10. The outer side 66 and the inner side 68 of the collar portion 60 have a collar width 65 that extends from the front side 62 to the rear side 64. The collar width 65 may be suited to, and depend upon, the size of the portable appliance 10, particularly the attachment hub 18. The collar width 65 may be between 0.2 and 1.0 inch in some implementations. In one exemplary embodiment, the collar width 65 is 0.63 inch.

A first opening 70 extends from the front side 62 to the rear side 64 of the collar portion 60. The first opening 70, defined by the inner side 68, may engage the attachment hub 18 when the handle 50 is installed to the portable appliance 10. In particular, the inner side 68 may slidingly engage the outer surface 32 of the attachment hub 18 such that a central axis, c, of the first opening 70 is axially aligned with a central axis, a, of the attachment hub 18 during advancement of the collar portion 60 along the attachment hub 18. Thus, the first opening 70 may have an inner collar diameter 71 that is sized to, and may be dependent upon, the dimensions of the attachment hub 18 of the portable appliance 10. The inner collar diameter 71 may be sized to at least allow the inner side 68 of the collar portion 60 to slide around the outer surface 32 of the attachment hub 18, and thus receive the attachment hub 18. In some implementations, the inner collar diameter 71 may be between 0.5 and 3.0 inches. More specifically, in some implementations, the inner collar diameter 71 may be between 1.0 and 2.0 inches. In one such exemplary embodiment, the inner collar diameter 71 is 1.58 inches.

The inner side 68 of the collar portion 60 may be the same material as the stem portion 80 and/or the grip portion 90, or it may have a texture or surface quality that enhances engagement of the outer surface 32 of the attachment hub 18. In other implementations, as illustrated in FIG. 3, the inner side 68 may have a liner 72 engaging at least a portion of the inner side 68 of the collar portion 60 to engage the outer surface 32 when disposed on the attachment hub 18. The liner 72 may extend from the inner side 68 or be positioned with an indent within the inner side 68. The liner 72 may also be any material suited to engage and/or enhance engagement with the outer surface 32, such as, but limited to, plastics, elastomers, rubbers, ceramics, cork, foams, or leathers. More specifically, the liner 72 may be a material having compressible, resistant, frictional, durable, and/or impermeable properties, such as, but not limited to, polyurethane foam, polyethylene foam, nitrile rubber, neoprene, silicone, fiberglass, resin, combinations thereof, and/or the like.

A second opening 74 may extend from the outer side 66 to the inner side 68 of the collar portion 60. The second opening 74 may be any size or shape, but may be particularly dimensioned to accommodate the fastening member 40 of the portable appliance 10, as the fastening member 40 may be received by both the second opening 74 and the opening 36 of the attachment hub 18. In this manner, the second opening 74 may be aligned with the opening 36 when the inner side 68 of the collar portion 60 engages the attachment hub 18. Accordingly, the second opening 74 may have an inner diameter 75, and/or a texture, shape, or surface feature, which may be the same as, or larger than, the opening 36, and suited to accommodate the fastening member 40. For example, the second opening 74 may have threading, rivets, ridges, grooves, bevels, bores, and/or the like. The inner diameter 75 of the second opening 74 may be any distance that less than the collar width 65 and less than a width of the fastening member 40 such that the fastening member 40, when disposed through the second opening 74 to engage the opening 36 will support and secure the handle 50 to the portable appliance 10. In some implementations, the inner diameter 75 is between 0.3 and 0.75 inches. In one embodiment, the inner diameter 75 is 0.32 inches.

The stem portion 80, extending outwardly from the collar portion 60, has a first end 82 which is contiguous with the outer side 66 of the collar portion 60, and a second end 84. The stem portion 80 may be any shape or have any stylistic features to enhance the handle 50 stability and/or aesthetic appeal. For example, in some embodiments, the first end 82 and/or second end 84, or the stem portion 80 generally, may have bends, curves, flaring, arms, texture, or other design features. In one such embodiment, as shown in FIGS. 3 and 4, the stem portion 80 may generally curve from the front side 62 of the collar portion 60 to the rear side 64 of the collar portion 60. The stem portion 80 may extend beyond either the front side 62 and/or the rear side 64 of the collar portion 60.

Extending from the stem portion 80, the grip portion 90 has a first end 92, contiguous with the second end 84 of the stem portion 80, and a second end 94. The grip portion 90 may have any shapes, contours, textures or other elements suited for gripping, friction, comfort, and/or ergonomics. For example, in some implementations the grip portion 90 may be widened or flared at the second end 94 and/or include raised regions, grooves, or indents (such as finger-sized grooves to increase ergonomic appeal of the handle 50). In some embodiments, the grip portion 90 may be tapered from the first end 92 to the second end 94. In some embodiments, as shown in FIG. 3, the grip portion may have an elongate shape. The second end 94 of the grip portion, as shown in FIGS. 3 and 4, may also be a free end.

The grip portion 90 may extend from the second end 84 of the stem portion 80 in any direction allowed by the portable appliance 10. In this aspect, the grip portion 90 may extend around the portable appliance, particularly the motor housing 14, in any direction or path that does not compromise or obstruct operation of the portable appliance 10. For example, as illustrated in FIG. 2B, the grip portion 90 may extend in a parallel relationship to motor housing 14.

In one aspect, the handle 50, including the collar portion 60, the stem portion 80, and/or the grip portion 90, may be composed of a durable material that provides shape retention and necessary strength to hold the weight of the portable appliance 10. The handle 50 may be any suitable rigid material or combinations of materials, such as, but not limited to, plastics, metals, or composites. In one exemplary embodiment, the handle 50 is fabricated from steel alloy. Additionally, the handle 50 be fully or partially coated with a film, finish, sealant, enamel, rubber, texture, and/or the like. For example, in one embodiment the handle 50 has a chrome mirror finish. In another embodiment, the handle 50 has a black industrial finish. Notably, some portions of the handle 50, particularly the grip portion 90, may be fabricated from additional materials suited to gripping, such as plastics, elastomers, rubbers, cork, foams, or leathers.

The collar portion 60 may attach to a portable appliance 10, via the attachment hub 18, to removably install the handle 50 on the motor housing 14 of the portable appliance 10. In other implementations, the handle 50 may be permanently installed to the portable appliance 10. When installed, the front side 62 of the collar portion 60 may generally face away from the motor housing 14, while the rear side 64 of the collar portion generally faces towards the motor housing 14.

The fastening member 40, received by both the opening 36 of the attachment hub 18 and the second opening 74 of the collar portion 60, may, for example, secure the handle 50 to the portable appliance 10 alone, such that no external attachment is received within the attachment hub 18 or the attachment hub 18 only receives the attachment hub cover 44. Alternatively, the handle 50 may be installed and utilized concomitantly with external attachments 100. In this aspect, any external attachment 100, the handle 50, and the portable appliance 10 may all function while installed.

Referring now to FIG. 5, shown therein is an illustration of an exemplary embodiment of an external attachment 100 constructed in accordance with the present disclosure. The external attachment 100 is shown for exemplary purposes as a meat grinder, however, it should be understood that the external attachment 100 may be any external attachment operable to be received by the attachment hub 18 as described above.

### CONCLUSION

Conventionally, portable appliances require the handling of heavy, potentially moving, parts in the course of normal relocation and operation. In accordance with the present disclosure, a handle with a collar portion that receives the attachment hub of a portable appliance is disclosed herein. The fastener mechanism of the portable appliance may secure the handle to the portable appliance.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A portable appliance, comprising:
a motor housing;
an attachment hub extending outward from the motor housing, the attachment hub having an outer surface with an opening;
a handle comprising:
a collar portion having a front side, a rear side, an outer side, an inner side defining a first opening extending from the front side to the rear side, the first opening receiving and engaging the outer surface of the attachment hub, and a second opening extending from the outer side of the collar portion to the inner side, the second opening aligned with the opening of the attachment hub;
a fastening member received within the opening of the attachment hub and extending through the second opening of the collar portion to secure the collar portion to the attachment hub;
a stem portion extending outwardly from the outer side of the collar portion, the stem portion having a first end contiguous with the outer side of the collar portion and a second end; and
a grip portion extending from the second end of the stem portion, the grip portion having a first end contiguous with the second end of the stem portion and a second end.

2. The portable appliance of claim 1, wherein the handle further comprises a liner extending along at least a portion of the inner side of the collar portion.

3. The portable appliance of claim 2, wherein the liner is comprised of a foam.

4. The portable appliance of claim 1, wherein the stem portion of the handle is curved from the first end to the second end.

5. The portable appliance of claim 4, wherein the stem portion of the handle curves from the front side of the collar portion toward the rear side of the collar portion.

6. The portable appliance of claim 1, wherein the first opening of the collar portion of the handle has a central axis, and wherein the grip portion extends in a parallel relationship to the central axis above the motor housing.

7. The portable appliance of claim 1, wherein the second end of the grip portion of the handle is a free end.

8. The portable appliance of claim 1, wherein the grip portion of the handle tapers from the first end of the grip portion to the second end thereof.

9. The portable appliance of claim 8, wherein the second end of the grip portion of the handle is a free end.

10. A handle for a portable appliance having an attachment hub and a fastening member, the attachment hub includes an outer surface with an opening for receiving the fastening member, the handle comprising:
a collar portion having a front side, a rear side, an outer side, an inner side defining a first opening extending from the front side to the rear side, the first opening receiving and engaging the outer surface of the attachment hub, and a second opening extending from the outer side of the collar portion to the inner side, the second opening aligned with the opening of the attachment hub;
a fastening member received within the opening of the attachment hub and extending through the second opening of the collar portion to secure the collar portion to the attachment hub;
a stem portion extending outwardly from the outer side of the collar portion, the stem portion having a first end contiguous with the outer side of the collar portion and a second end; and
a grip portion extending from the second end of the stem portion, the grip portion having a first end contiguous with the second end of the stem portion and a second end.

11. The portable appliance of claim 10, wherein the handle further comprises a liner extending along at least a portion of the inner side of the collar portion.

12. The portable appliance of claim 11, wherein the liner is comprised of a foam.

13. The portable appliance of claim 10, wherein the stem portion of the handle is curved from the first end to the second end.

14. The portable appliance of claim 13, wherein the stem portion of the handle curves from the front side of the collar portion toward the rear side of the collar portion.

15. The portable appliance of claim 10, wherein the first opening of the collar portion of the handle has a central axis, and wherein the grip portion extends in a parallel relationship to the central axis above a motor housing.

16. The portable appliance of claim 10, wherein the second end of the grip portion of the handle is a free end.

17. The portable appliance of claim 10, wherein the grip portion of the handle tapers from the first end of the grip portion to the second end thereof.

18. The portable appliance of claim 17, wherein the second end of the grip portion of the handle is a free end.
